(19) United States
(12) Patent Application Publication
(10) Pub. No.: US 2008/0229350 A1
(43) Pub. Date: Sep. 18, 2008

(54) Disc Cleaning Device

(76) Inventors: Kuniko Nakata, Osaka (JP); Hironori Okazawa, Osaka (JP); Teruyuki Takizawa, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/597,444

(22) PCT Filed: Oct. 15, 2004
(86) PCT No.: PCT/JP2004/015678

§ 371 Date: Jul. 26, 2006

(30) Foreign Application Priority Data
Jan. 30, 2004 (JP) 2004-023840

(51) Int. Cl. G11B 7/24

(52) U.S. Cl. 720/719

(57) ABSTRACT

A disc cleaner includes: a supporting body 11 including a first holding plane 12a, a disc supporting plane 13 and a convex portion 14, where the first holding plane 12a holds a first type of disc cartridge, which exposes one side of a disc therein and which includes a rotational member for opening and closing shutters, such that the exposed side of the disc faces the first holding plane 12a, the disc supporting plane 13 is located higher than the first holding plane 12a and contacts with a non-storage region of the disc around its center hole, thereby supporting the disc thereon, and the convex portion 14 fits into the center hole of the disc so as to stick out of the center hole; a shutter driving member 31 for turning the rotational member of the first type of disc cartridge; and a rotary knob 21 including a contact plane that contacts with the non-storage region of the disc around its center hole and a concave portion that fits the convex portion so as to turn against the convex portion.

### TECHNICAL FIELD

The present invention relates to a device for cleaning an optical disc stored in a cartridge.

### BACKGROUND ART

Conventional videotapes have been gradually replaced by large-capacity optical discs on which video can be stored. Those optical discs have such high densities that data may not be read from, or written on, them properly if the data storage side thereof is soiled with dust or gets scratched. To avoid those situations, optical discs stored in cartridges have been developed.

In a storage device in which an optical disc is stored in a cartridge, the cartridge includes a shutter. In the following description, a cartridge storing an optical disc therein will be simply referred to herein as a “disc cartridge”. When the disc cartridge is loaded into a read/write drive, the shutter is opened, thereby letting a read/write head access the data storage side of the optical disc. However, if the disc cartridge has been unloaded from the read/write drive, the shutter has already been closed. Thus, the optical disc is protected from dust and scratches during storage.

As long as the optical disc is used in a normal condition, such operation of the shutter prevents dust from being deposited on the optical disc in the disc cartridge. In the read/write drive, however, the shutter of the disc cartridge is opened and dust may enter the disc cartridge through the opened window and deposit on the optical disc. Once dust has deposited on the optical disc, it is difficult to remove the dust out of the disc cartridge because the shutter is closed during storage.

To overcome such a problem, disc cleaners for cleaning an optical disc stored in a disc cartridge have been proposed.

For example, Japanese Patent Application Laid-Open Publication No. 11-273313 discloses a disc cleaner including a body with a shutter stopper. The shutter stopper can keep the shutter, which opens and closes by a sliding mechanism, opened.

This disc cleaner can change the positions of the shutter stopper so as to be loaded with, and clean, two different types of cartridges.

However, this structure can be used effectively only in a cartridge with a shutter that opens and closes by the sliding mechanism. Thus, the structure cannot cope with a disc cartridge in which a disc is stored with one side exposed and which includes a rotational member for opening and closing the shutter as disclosed in pamphlet of PCT International Application Publication No. 03/041076.

### DISCLOSURE OF INVENTION

In order to overcome the problems described above, an object of the present invention is to provide a disc cleaner that can accept such a disc cartridge, in which a disc is stored with one side exposed and which opens and closes a shutter by turning a rotational member, and that can open and close the shutter safely and just as intended by using a simple structure.

A disc cleaner according to the present invention includes: a supporting body including a first holding plane, a disc supporting plane and a convex portion, wherein the first holding plane holds a first type of disc cartridge, which exposes one side of a disc therein and which includes a rotational member for opening and closing shutters, such that the exposed side of the disc faces the first holding plane, the disc supporting plane is located higher than the first holding plane and contacts with a non-storage region of the disc around its center hole, thereby supporting the disc thereon, and the convex portion fits into the center hole of the disc so as to stick out of the center hole; a shutter driving member for turning the rotational member of the first type of disc cartridge; and a rotary knob including a contact plane that contacts with the non-storage region of the disc around its center hole and a concave portion that fits the convex portion so as to turn against the convex portion.

In one preferred embodiment, the supporting body further includes a second holding plane for holding a second type of disc cartridge with a shutter that opens and closes by sliding, and a shutter stopper for keeping the shutter of the second type of disc cartridge opened, and the disc supporting plane is located higher than the second holding plane.

In another preferred embodiment, the first holding plane is located between the second holding plane and the disc supporting plane.

In another preferred embodiment, the shutter driving member includes an interlocking portion that interlocks with a shutter operating portion provided for the rotational member of the first type of disc cartridge and a knob portion, and slides parallel to a side surface of the first type of disc cartridge with the rotational member and with respect to the supporting body.

In another preferred embodiment, the disc cleaner further includes a cap member for sandwiching at least a part of the interlocking portion of the shutter driving member between the supporting body and itself such that the shutter driving member will not drop off the supporting body, and the cap member is attached to the supporting body.

In another preferred embodiment, the supporting body further includes an elastic member for applying elastic force to the first type of disc cartridge toward the shutter driving member.

In another preferred embodiment, the supporting body has a first groove, which extends parallel to the side surface of the first type of disc cartridge with the rotational member when the disc cartridge is held, and the shutter driving member includes a first protrusion that fits into the first groove.

In another preferred embodiment, the supporting body and the shutter driving member engage with each other such that the first protrusion of the shutter driving member does not come off the first groove of the supporting body.

In another preferred embodiment, the supporting body has a first side, for which the first and second holding planes are defined, and a second side that is opposite to the first side. The first and second sides have a first groove and a second groove, respectively, which extend parallel to the side surface of the first type of disc cartridge with the rotational member. And the shutter driving member has a first protrusion and a second protrusion, which stick out so as to face each other and which fit into the first and second grooves, respectively.

In another preferred embodiment, the disc cleaner further includes a lid that covers at least the first type of disc cartridge held on the first holding plane of the supporting body, and the lid has an opening corresponding to a window of the first type of disc cartridge that exposes when the shutters open.

In another preferred embodiment, the lid is supported in a rotatable position near one side surface of the supporting body.

In another preferred embodiment, the lid is supported on the supporting body so as to be readily removable from, and attachable to, the supporting body.

In another preferred embodiment, the lid has a side surface extending toward the supporting body around the opening.

In another preferred embodiment, the lid has a raised position regulating portion on one side that faces the supporting body, and the position regulating portion regulates vertical motion of the first type of disc cartridge that is held on the supporting body.

In another preferred embodiment, at least part of the lid is transparent to the point that the first type of disc cartridge held on the first holding plane of the supporting body is seen though the lid.

In another preferred embodiment, the lid has a first groove, which extends substantially parallel to the side surface of the first type of disc cartridge with the rotational member when the disc cartridge is held, and the shutter driving member has a first protrusion that fits into the first groove.

In another preferred embodiment, the lid and the shutter driving member engage with each other such that the first protrusion of the shutter driving member does not come off the first groove of the lid.

In another preferred embodiment, the lid has a first side that faces the supporting body and a second side that is opposite to the first side. The first and second sides have a first groove and a second groove, respectively, which extend parallel to the side surface of the first type of disc cartridge with the rotational member. And the shutter driving member has a first protrusion and a second protrusion, which stick out so as to face each other and which fit into the first and second grooves, respectively.

In another preferred embodiment, the shutter driving member has a third protrusion. The supporting body has a third groove, which extends parallel to the side surface of the first type of disc cartridge with the rotational member when the disc cartridge is held, and which fits with the third protrusion of the shutter driving member, and a notch that communicates with the third groove such that the third protrusion of the shutter driving member is inserted into the third groove when the lid is attached to the supporting body so as to cover the first type of disc cartridge.

In another preferred embodiment, at least one of the shutter driving member and the lid has a fixing structure for fixing the shutter driving member onto the lid at a position where the third protrusion of the shutter driving member is insertable into the notch that communicates with the third groove.

In another preferred embodiment, the interlocking portion of the shutter driving member includes a rack and first and second fitting portions, which respectively engage with a gear portion and first and second notches that are provided for the rotational member of the first type of disc cartridge. The gear portion is interposed between the first and second notches. The first and second fitting portions are supported elastically on the rack so as to sandwich the rack between themselves.

In another preferred embodiment, the first fitting portion has a protrusion and contacts with the rotational member earlier than the second fitting portion in opening the shutters of the first type of disc cartridge. The supporting body has a guide groove that receives the protrusion of the first fitting portion. If the shutter driving member has been moved so as to open the shutters of the first type of disc cartridge, the guide groove drives the protrusion of the first fitting portion such that the first fitting portion contacts with a portion of the rotational member of the first type of disc cartridge other than the first notched portion and keeps the rotational member from turning, thereby retracting the first fitting portion.

In another preferred embodiment, the convex portion of the supporting body has two notched portions so as not to interfere with protrusions that are provided for the second type of disc cartridge so as to stick out of the center hole of the disc.

In another preferred embodiment, the supporting body includes a storage portion for storing the rotary knob and another storage portion for storing a bottle of a cleaning liquid for cleaning the first disc.

### BRIEF DESCRIPTION OF DRAWINGS

FIG. 1 is an exploded perspective view illustrating a first preferred embodiment of a disc cleaner according to the present invention.

FIG. 2 is a plan view illustrating how a first type of disc cartridge is held on the disc cleaner shown in FIG. 1.

FIG. 3 is a plan view illustrating how the shutters of the first type of disc cartridge shown in FIG. 2 have been opened.

FIG. 4 is a cross-sectional view of the elastic member shown in FIG. 3.

FIG. 5 is a plan view illustrating how a second type of disc cartridge is held on the disc cleaner shown in FIG. 1.

FIG. 6 is a cross-sectional view illustrating the disc cleaner shown in FIG. 3.

FIG. 7 is a cross-sectional view illustrating the disc cleaner shown in FIG. 5.

FIG. 8 is a perspective view illustrating how a rotary knob and a cleaning liquid bottle are stored in the disc cleaner shown in FIG. 1.

FIG. 9 is an exploded perspective view illustrating a second preferred embodiment of a disc cleaner according to the present invention.

FIG. 10(a) is a plan view of the disc cleaner shown in FIG. 9, and FIG. 10(b) is a cross-sectional view of the shutter driving member attached to the supporting body.

FIG. 11 is a plan view illustrating how the disc cleaner shown in FIG. 9 works when the shutter driving member is slid.

FIG. 12 is a plan view illustrating how the disc cleaner shown in FIG. 9 works when the shutter driving member is further slid.

FIG. 13 is a plan view illustrating how the disc cleaner shown in FIG. 9 works when the shutter driving member is slid even further.

FIG. 14 is an exploded perspective view illustrating a third preferred embodiment of a disc cleaner according to the present invention.

FIG. 15 is a perspective view illustrating how the disc cleaner shown in FIG. 14 looks when its lid is opened.

FIGS. 16(a) and 16(b) are respectively a top view and a side view illustrating how the disc cleaner shown in FIG. 14 looks when its lid is opened.

FIG. 17(a) is a top view of the disc cleaner shown in FIG. 14 and FIG. 17(b) is a cross-sectional view of its shutter driving member.

FIG. 18(a) is a plan view illustrating the reverse side of the lid and FIG. 18(b) is a partial enlarged view thereof.

FIG. 19 is a perspective view illustrating a first type of cartridge.

FIG. 20 is an exploded perspective view of the first type of cartridge.

### BEST MODE FOR CARRYING OUT THE INVENTION

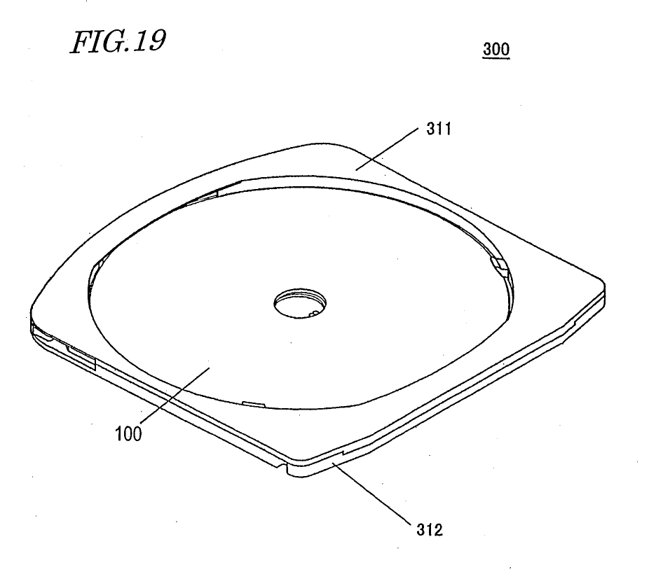

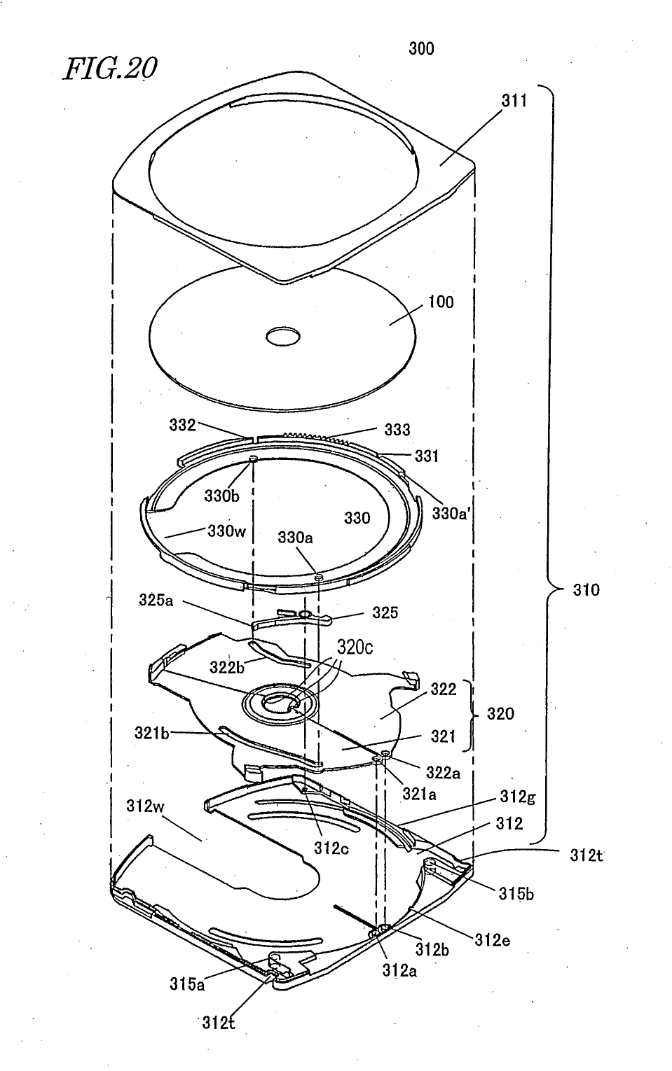

First, a disc cartridge that fits the disc cleaner of the present invention will be described. FIGS. 19 and 20 illustrate a first type of disc cartridge 300 that can be loaded into the disc cleaner of the present invention. As shown in FIGS. 19 and 20, the disc cartridge 300 has a cartridge body 310 including an upper shell 311 and a lower shell 312, a disc 10 stored in the cartridge body 310, a window 312w of the lower shell 312, a shutter portion 320 for opening and closing the window 312w to/from the outside, and a rotational member 330.

As shown in FIGS. 19 and 20, the upper shell 311 has a window that exposes one side of the disc 10 substantially entirely. Thus, while the disc 10 is stored in the cartridge body 310, one side of the disc 10, e.g., the label side thereof, is exposed through the window of the upper shell 311. Rotation spindles 312a and 312b functioning as the axes of rotation of the shutter portion are provided on the inner surface of the lower shell 312. Also, positioning holes 315a and 315b are made on the outer surface of the lower shell 312. Another window 312g is provided on a side surface of the cartridge body 310.

The shutter portion 320 includes a first shutter 321 and a second shutter 322. The first and second shutters 321 and 322 respectively have guide grooves 321b and 322b and rotation holes 321a and 322a, to which the rotation spindles 312a and 312b are inserted.

The rotational member 330 includes a flat ring-like portion and a cylindrical side surface located outside of the ringlike portion. Link spindles 330a and 330b to be inserted into the guide grooves 321b and 322b, respectively, are provided on the surface of the ringlike portion that is opposed to the shutter portion 320. The ringlike portion further has a notched portion 330w. Also, the side surface has a first notched portion 331, a second notched portion 332 and a gear portion 333 interposed between them. These portions together function as a shutter operating member.

The disc cartridge 300 further includes a locking member 325, which is supported so as to turn on a spindle 312c. The locking member 325 has a raised portion 325a. When the shutter portion 320 is closed, the raised portion 325a fits into the second notched portion 332, thereby preventing the rotational member 330 from turning.

The rotational member 330 interlocks with the shutter portion 320 by way of the guide grooves 321b and 322b and the link spindles 330a and 330b. By turning the rotational member 330, the shutter portion 320 can open or close the window 312w. To turn the rotational member 330, the first and second notched portions 331 and 332 and gear portion 333, which are exposed through the window 312g on the side surface of the cartridge body 310, should get engaged with a shutter opening/closing mechanism provided for a disc drive, for example.

As described above, the first type of disc cartridge stores a disc therein with one side thereof exposed and slides an operating member on one of its side surfaces parallel to the disc, thereby opening shutters interlocked with its rotational member and exposing a part of the data storage side of the disc. The first type of disc cartridge is preferably a cartridge for a Blu-ray Disc. It should be noted that the first type of disc cartridge does not have to have quite the same structure as that illustrated in FIGS. 19 and 20. But the first type of disc cartridge just needs to have such a structure that stores a disc therein with one side thereof exposed and slides an operating member on one of its side surfaces parallel to the disc, thereby opening shutters interlocked with its rotational member and exposing a part of the data storage side of the disc. The operating member may have a different structure but is preferably made up of the first and second notched portions 331 and 332 and the gear portion 333.

A second type of disc cartridge that can be loaded into the disc cleaner of the present invention has the same structure as the cartridge disclosed in Japanese Patent Application Laid-Open Publication No. 11-273313. More specifically, the second type of disc cartridge includes a rectangular, airtight sliding shutter. By sliding the shutter, a window that exposes the data storage side of an optical disc and a non-storage region to chuck the disc is opened. The second type of disc cartridge is preferably a cartridge for a DVD-RAM.

### EMBODIMENT 1

Hereinafter, a first preferred embodiment of a disc cleaner according to the present invention will be described with reference to the accompanying drawings.

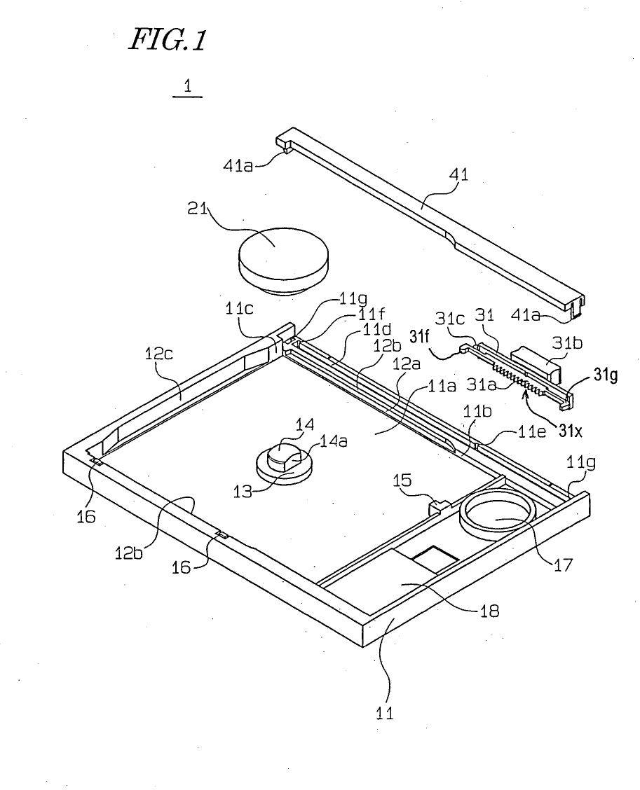

As shown in FIG. 1, the disc cleaner 1 includes a supporting body 11, a rotary knob 21, a shutter driving member 31 and a cap member 41. These members are preferably made of a synthetic resin, for example. However, not all of these members have to be made of the same material. But the best materials are selected for the respective members with the strengths and appearances required for these members taken into consideration.

The supporting body 11 has a first holding plane 12a for holding the first type of disc cartridge 300 thereon, a first pair of sidewalls 12b, which rises perpendicularly upward from the first holding plane 12a, and a first rear end wall 12c, which also rises perpendicularly upward from the first holding plane 12a.

The supporting body 11 also has a second holding plane 11a for holding the second type of disc cartridge 51 (see FIG. 5) thereon, a second pair of sidewalls 11b, which rise perpendicularly upward from the second holding plane 11a, and a second rear end wall 11c, which also rises perpendicularly upward from the second holding plane 11a.

Substantially at the center of the second holding plane 11a, provided are a disc supporting plane 13 for supporting the disc 100 thereon by contacting with the non-storage region of the disc 100 around its center hole and a convex portion 14, which fits into the center hole of the disc 100, is concentric with the disc supporting plane 13, and has two D-cut notches 14a.

Also, the first holding plane 12a is located at a level between the second holding plane 11a and the disc supporting plane 13. This point will be described in further detail later.

The shutter driving member 31 includes an interlocking portion 31x and a knob portion 31b. The interlocking portion 31x has a structure that interlocks with the operating portion of the rotational member in the first type of disc cartridge 300. More specifically, the interlocking portion 31x includes a rack portion 31a that engages with the gear portion 333 and first and second fitting portions 31f and 31g that fit into the first and second notches 331 and 332, respectively. The first and second fitting portions 31f and 31g are supported elastically on the rack portion 31a so as to sandwich the rack portion 31a between themselves. The shutter driving member 31 includes a protrusion that fits into a groove 11d provided for the supporting body 11 so as to slide along the groove 11d freely. The groove 11d is provided near, and parallel to, a side surface of the first type of disc cartridge 300 with the rotational member 330.

The interlocking portion 31x includes a locking portion 31c. While the shutter driving member 31 is not used, the locking portion 31c gets locked with a first locking fit portion 11e that communicates with the groove 11d of the supporting body 11. On the other hand, when the shutters 320 are kept opened by using the shutter driving member 31, the locking portion 31c of the shutter driving member 31 gets locked with a second locking fit portion 11f that also communicates with the groove 11d of the supporting body 11.

To prevent the shutter driving member 31 from dropping off, the rack portion 31a is covered with a cap member 41. The cap member 41 has two fixing tabs 41a to be fixed onto two fixing walls 11g of the supporting body 11 such that the shutter driving member 31 does not come off. The cap member 41 just needs to sandwich at least a part of the interlocking portion 31x between the supporting body 11 and itself.

An elastic member 16 is provided on one of the sidewalls 12b of the first pair, which is opposite to the other sidewall 12b with the shutter driving member 31. This elastic member 16 applies elastic force to the first type of disc cartridge 300 toward the shutter driving member 31.

A shutter stopper 15 is provided so as to rise perpendicularly upward from the second holding plane 11a. When the second type of disc cartridge 51 is held on the second holding plane 11a, the shutter stopper 15 keeps the shutter 52 opened.

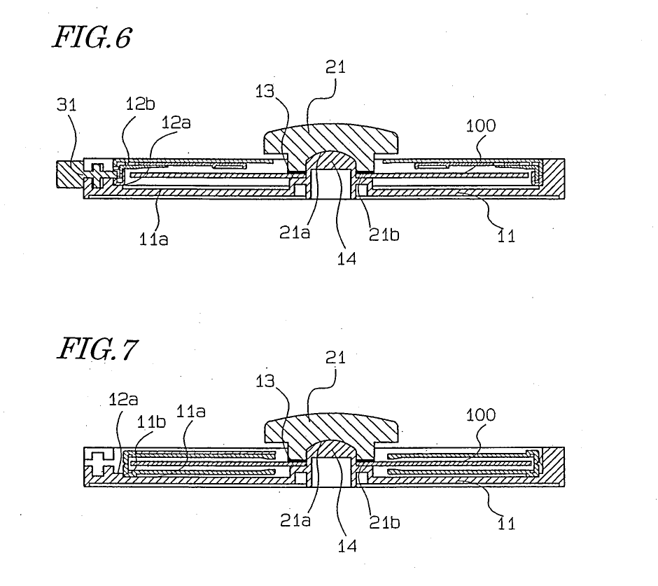

As shown in FIGS. 6 and 7, the rotary knob 21 includes a concave portion 21a that fits with the convex portion 14 and an antislip portion 21b. The concave portion 21a fits with the convex portion 14 so as to turn around the convex portion 14. The antislip portion 21b contacts with a non-storage region of the disc 100 around the center hole thereof and turns the disc 100 without slipping it as the rotary knob 21 is turned.

On a front end portion of the supporting body 11, provided are a rotary knob storage portion 17 and a cleaning liquid bottle storage portion 18.

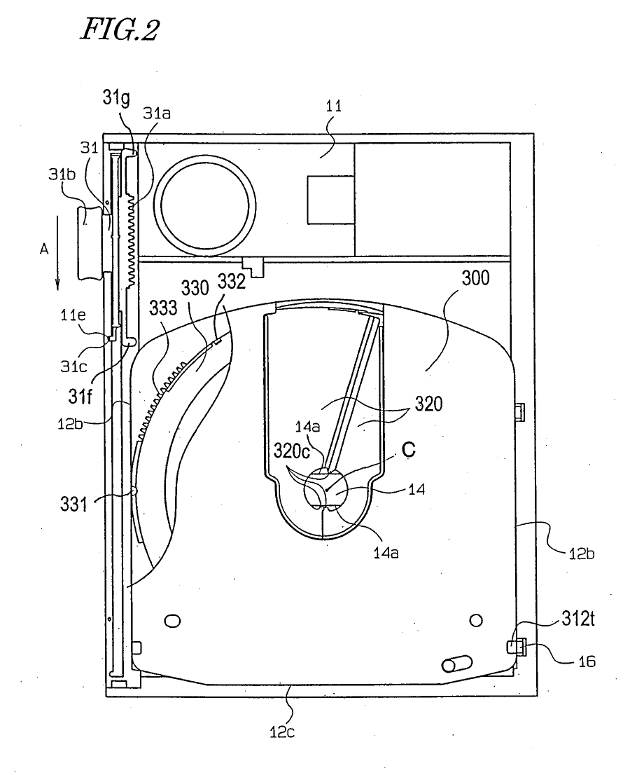

Hereinafter, it will be described with reference to FIGS. 2 through 7 how to clean the data storage side of the disc 100 that is stored in either the first type of disc cartridge 300 or the second type of disc cartridge 51.

FIG. 2 illustrates how the first type of disc cartridge 300 is held on the disc cleaner 1.

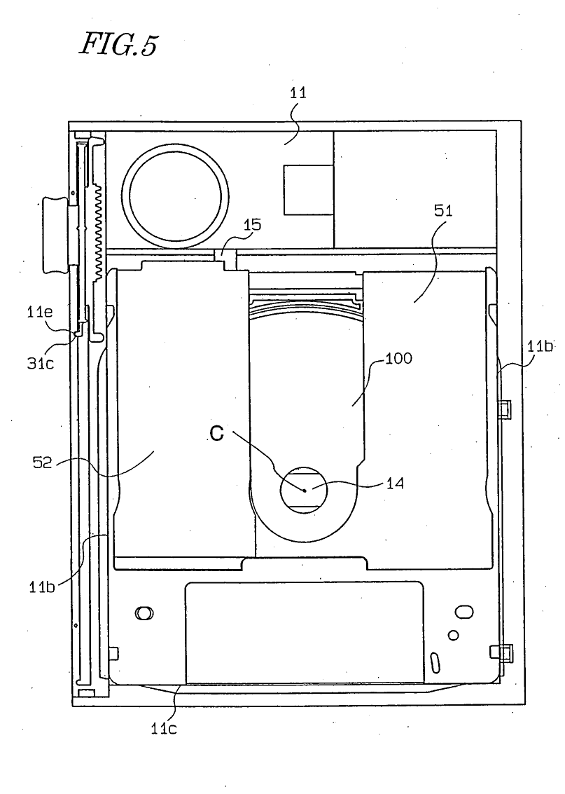

While the locking portion 31c of the shutter driving member 31 is locked with the first locking fit portion 11e in the front end portion of the supporting body 11, the first type of disc cartridge 300 with closed shutters 320 is held on the first holding plane 12a of the disc cleaner 1 with the shutters faced upward. That is to say, the disc cartridge 300 is held such that the data storage side of the disc faces upward and that the label side exposed through the window faces the supporting body 11. The first type of disc cartridge 300 has its position regulated by the first pair of sidewalls 12b and the first rear end wall 12c. At the same time, the elastic member 16 fits into a recess 312t on the side surface of the first type of disc cartridge 300 as shown in FIG. 4. As a result, elastic force is applied to the first type of disc cartridge 300 toward the shutter driving member 31 and the disc cartridge 300 is pressed and fixed so as not to come off upward.

In this case, as for the disc 100 stored in the first type of disc cartridge 300, the non-storage region thereof around its center hole contacts with, and is supported by, the disc supporting plane 13. In the first type of disc cartridge 300 in the closed state, the shutters 320 make a hole over the center hole of the disc 100. This hole has three protrusions 320c for preventing the storage area of the disc 100 from getting scratched. The convex portion 14 fits into the center hole of the disc 100 but has two D-cut notches 14a so as to avoid interference with the protrusions 320c of the shutters 320. It should be noted that the distance L1 from the center C of the convex portion 14 to one of the sidewalls 12b of the first pair with the shutter driving member 31 is set longer than the distance L2 from the center C of the convex portion 14 to the other sidewall 12b of the first pair. This is because in this disc cartridge 300, the disc 100 is held so as to be slightly offset from the center of the disc cartridge.

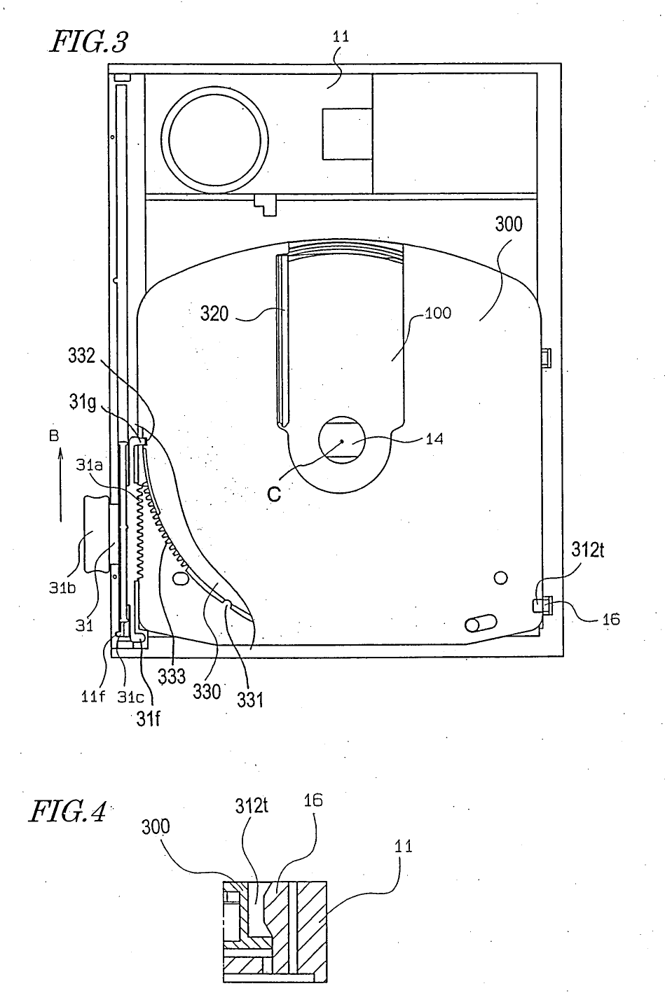

After the disc cartridge 300 has been loaded in this manner, the knob portion 31b of the shutter driving member 31 is shifted in the direction pointed by the arrow A. Then, the first fitting portion 31f fits into the first notch 331 while the locking member 325 (see FIG. 20) is pressed by the rack portion 31a of the interlocking portion 31x. As a result, the rotational member 330, which has been locked by the locking member 325, is now unlocked and free to turn. Accordingly, if the shutter driving member 31 is further shifted in the arrow A direction, then the first fitting portion 31f turns the rotational member 330. As the shutter opening/closing portion 31 further moves, the rack portion 31a soon gets engaged with the gear portion 333 of the rotational member 330 and the second fitting portion 31g soon fits into the second notched portion 332, thus further turning the rotational member 330. As a result, the shutters 320 open as shown in FIG. 3 and the data storage side of the disc 100 is exposed. When the rack portion 31a is further moved toward the rear end portion to the point that the locking portion 31c gets locked with the second locking fit portion 11f, the opening operation ends. In this state, i.e., in a situation where the first type of disc cartridge 300 is held on the supporting body 11 with the shutters 320 opened, the rotational member 330 of the first type of cartridge 300 is engaged with the shutter driving member 31. That is why the first type of cartridge 300 cannot be removed in that state.

By turning the rotary knob 21 in such a state with the knob 21 fitted with the convex portion 14, the disc 100 can be rotated due to a friction caused between the rotary knob 21 and the disc 100. To clean the data storage side of the disc 100, a piece of cleaning cloth may be dampened with the cleaning liquid in the cleaning liquid bottle 71, put on the disc 100 and then moved in the disc radial direction, thereby wiping out the dust and dirt deposited on the data storage side of the disc 100. Once the exposed portion of the data storage side has been cleaned in this manner, the disc 100 is rotated by further turning the rotary knob 21 and the cleaning operation described above is repeated. Then, the entire data storage side of the disc 100 can be cleaned soon. When the cleaning operation is finished, the knob portion 31b of the shutter driving member 31 is moved in the direction pointed by the arrow B in FIG. 3. Then, the rotational member 330 turns in the opposite direction and the shutters 320 will soon be closed as shown in FIG. 2. In that state, the first type of disc cartridge 300 can be removed from the supporting body 11.

FIG. 5 illustrates how the second type of disc cartridge 51 is held on the disc cleaner 1. The second type of disc cartridge 51 has a rectangular shape and has a U-shutter 52 attached at its front end so that the shutter 52 can slide horizontally.

To load the second type of disc cartridge 51 into the disc cleaner, first, the disc cartridge 51 is held upside down on the second holding plane 11a with its shutter 52 opened. That is to say, the disc cartridge 51 is held such that the data storage side of the disc 100 is exposed and faced upward. In this case, the second type of disc cartridge 51 has its horizontal position regulated by the second pair of opposed sidewalls 11b of the supporting body 11, its rear end position regulated by the second rear end wall 11c and its front end position regulated by the shutter stopper 15. As a result, the second type of disc cartridge 51 is held on the supporting body 11 with its shutter 52 kept opened and the data storage side of the disc 100 exposed.

At this point in time, the non-storage region surrounding the center hole of the disc 100 stored in the second type of disc cartridge 51 contacts with, and is supported by, the disc supporting plane 13. The convex portion 14 fits into the center hole of the disc 100. The distances from the center C of the convex portion 14 to the two sidewalls 11 of the second pair are equal to each other.

By turning the rotary knob 21 in such a state with the knob 14 fitted into the convex portion 14, the disc 100 can be rotated. The method of cleaning the data storage side of the disc 100 is the same as the method of cleaning the disc 100 in the first type of disc cartridge 300 described above, and detailed description thereof will be omitted herein. When the cleaning operation is finished, the second type of disc cartridge 51 is removed from the supporting body 11. Then, the shutter 52 will automatically slide and close itself by the action of a spring (not shown) included in the cartridge.

Next, the level relationship between the first holding plane 12a, second holding plane 11a and disc supporting plane 13 will be described. FIG. 6 is a cross-sectional view illustrating how the first type of disc cartridge 300 is held on the first holding plane 12a. Meanwhile, FIG. 7 is a cross-sectional view illustrating how the second type of disc cartridge 51 is held on the second holding plane 11a.

The disc 100 is received and supported by the disc supporting plane 13 and the center hole of the disc 100 fits into the convex portion 14.

The first and second types of disc cartridges 300 and 51 have substantially equal thicknesses. However, the first type of disc cartridge 300 that exposes one side of the disc and the second type of airtight cartridge 51 have quite different internal structures. That is to say, the storage position of the disc 100 with respect to the upper and lower shells of one type of disc cartridge is different from that of the disc 100 in the other type of disc cartridge.

That is why if both types of disc cartridges were held on the same holding plane with the disc 100 also supported on the same disc supporting plane 13, then the data storage side of the disc 100 would contact with the inner walls of the disc cartridge of either type. And if the disc 100 were rotated in such a state with the rotary knob 21, the data storage side would get scratched.

Thus, to avoid those scratches, the first and second holding planes 12a and 11a are defined herein at mutually different levels. More specifically, the first holding plane 12a is defined between the second holding plane 11a and the disc supporting plane 13. That is to say, the first holding plane 12a is located at a higher level than the second holding plane 11a.

As a result, no matter whether the first type of disc cartridge 300 or the second type of disc cartridge 51 is held with the disc 100 supported on the disc supporting plane 13, the disc 100 can always be located substantially at the intermediate level of the inner wall space of the first or second type of disc cartridge 300 or 51.

A preferred embodiment of the present invention has been described on how to clean the disc 100 in the disc cartridge. However, a disc 100 that is not stored in any disc cartridge can also be cleaned.

In that case, the center hole of the disc 100 is fitted into the convex portion 14 and the non-storage region on the reverse side of the disc 100, surrounding the center hole, is received and supported by the disc supporting plane 13. By turning the rotary knob 21 in such a state with the knob 14 fitted into the convex portion 14, the disc 100 can be rotated. The method of cleaning the data storage side of the disc 100 is the same as the method of cleaning the disc 100 stored in the first type of disc cartridge 300 described above, and detailed description thereof will be omitted herein.

As described above, the disc cleaner of this preferred embodiment can clean a disc that is stored with one side thereof exposed in the first type of disc cartridge 300 where the shutters are opened and closed by turning the rotational member, a disc that is stored in the second type of rectangular and airtight disc cartridge 51 with a sliding shutter, and a bare disc that is not stored in any disc cartridge.

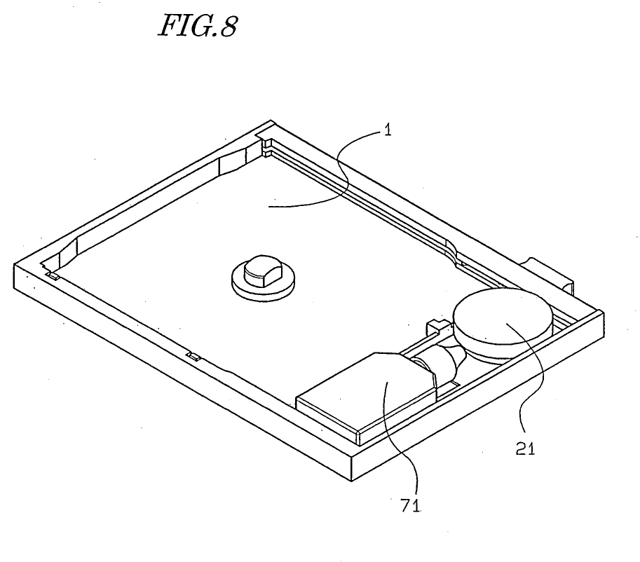

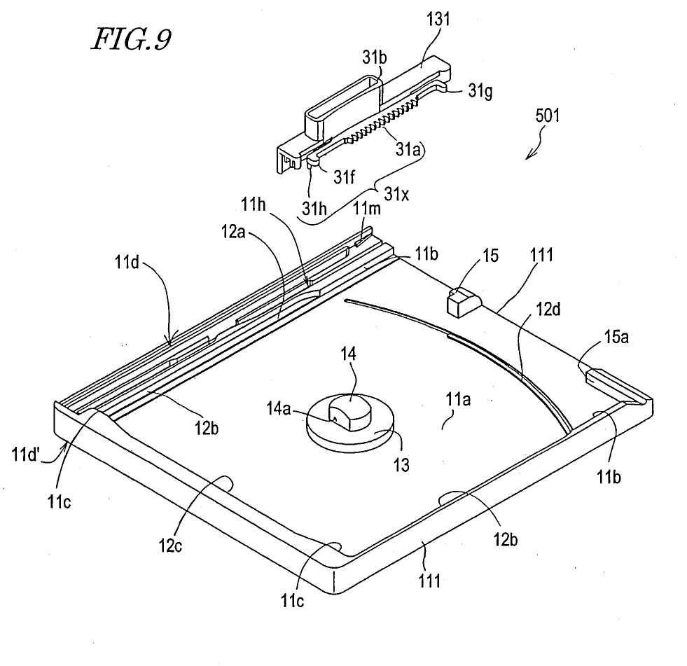

In addition, since the supporting body 11 includes storage recesses 17 and 18 for storing the rotary knob 21 and cleaning liquid bottle 71, respectively, as shown in FIGS. 8 and 1, the disc cleaner can be stored anywhere as a kit.

In the preferred embodiment described above, the cap member 41 is formed separately from the supporting body 11. However, the cap member 41 may be shaped as a hinge by a resin molding process so as to form an integral part of the supporting body 11.

Furthermore, if the shutter driving member 31 has an engaging shape that never allows the member 31 to come off the supporting body 11, then the cap member may be omitted. In that case, the number of necessary parts can be reduced and the overall cost can be cut down.

In the preferred embodiment described above, the second type of disc cartridge 51 keeps the shutter 52 opened. Optionally, a sliding mechanism for opening the shutter 52 of the second type of disc cartridge 51 may be provided at the front end portion of the supporting body 11. Then, the shutter 52 can also be kept closed and can be held more easily.

The rotary knob 21 described for the foregoing preferred embodiment can turn freely. And it is difficult to know to what degree the disc 100 has rotated (i.e., how much the disc 100 has been cleaned). Thus, the rotary knob 21 may have scales or indices so as to turn a distance that is smaller than the opening width of the shutters every time. As another alternative, the disc cleaner may also have a structure in which the rotary knob 21 and convex portion 14 can loosely fit with each other every time the rotary knob 21 has turned to that degree.

### EMBODIMENT 2

Hereinafter, a second preferred embodiment of a disc cleaner according to the present invention will be described with reference to the accompanying drawings.

FIG. 9 is an exploded perspective view of a disc cleaner 501. The disc cleaner 501 includes a supporting body 111 and a shutter driving member 131. The disc cleaner 501 further includes a rotary knob, which is not shown in FIG. 9 because the knob has the same structure as the rotary knob 21 of the first preferred embodiment. Also, any component of this preferred embodiment, having the same function as the counterpart of the first preferred embodiment described above, is identified by the same reference numeral.

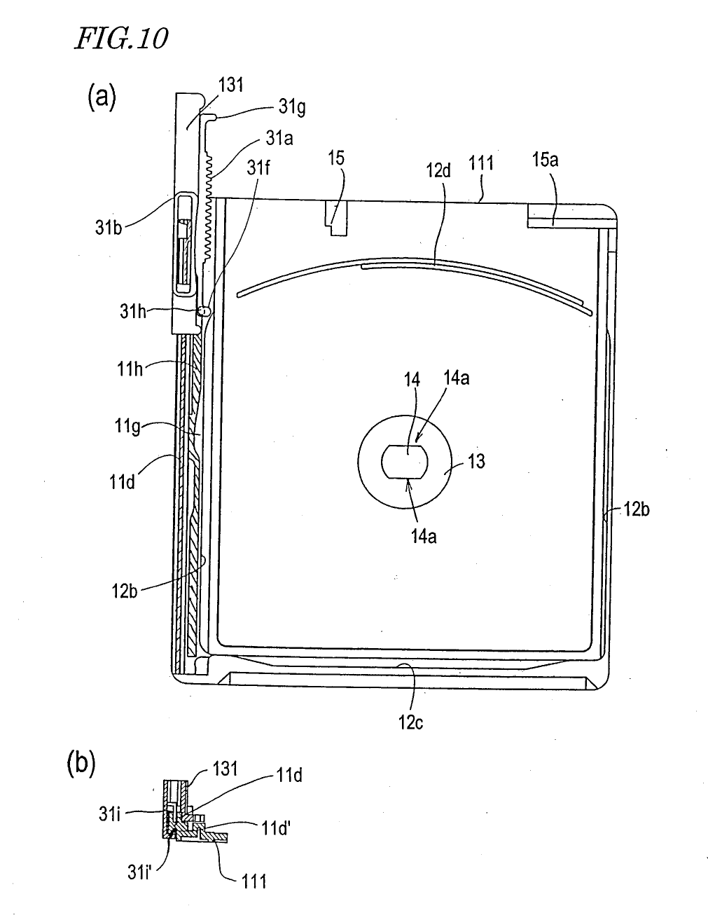

FIG. 10(a) is a plan view of the supporting body 111 to which the shutter driving member 131 has been attached. FIG. 10(b) is a cross-sectional view of the shutter driving member 131 attached to the supporting body 111 as viewed perpendicularly to the sliding direction thereof. Hereinafter, the structure of the disc cleaner 501 will be described in further detail with reference to FIGS. 9, 10(a) and 10(b).

As in the first preferred embodiment described above, the supporting body 111 also has the first holding plane 12a, second holding plane 11a, disc supporting plane 13, convex portion 14 and shutter stopper 15. These members and portions function in quite the same way as their counterparts of the first preferred embodiment. Also, a front end wall 15a is provided on the second holding plane 11a for the second type of cartridge 51.

A protrusion 12d that contacts with the front end of the first type of disc cartridge 300 to hold the disc cartridge 300 thereon is further provided on the second holding plane 11a. To make the position to put the first type of disc cartridge 300 easily recognizable on the supporting body 111, a groove that extends along the profile of the first type of disc cartridge 300 may be cut just outside of the protrusion 12d.

On one side of the supporting body 111 on which the first and second holding planes 12a and 11a are defined, a groove 11d and a guide groove 11h are provided (as indicated by hatching in FIG. 10). Also, another groove 11d′ is cut on the other side of the supporting body 111. When the first type of disc cartridge 300 is held on the supporting body 111, these grooves 11d and 11d′ extend substantially parallel to the side surface of the first type of disc cartridge 300 with the rotational member 330. A stopper portion 11m is provided at one end of the groove 11d.

The shutter driving member 131 also includes the interlocking portion 31x and knob portion 31b. As in the first preferred embodiment, the interlocking portion 31x includes first and second fitting portions 31f and 31g and a rack portion 31a. A protrusion 31h is provided for the first fitting portion 31f. The shutter driving member 31 includes protrusions 31i and 31i′, which stick out so as to face each other and respectively fit into the grooves 11d and 11d′ of the supporting body 111.

As shown in FIGS. 10(a) and 10(b), the protrusions 31i and 31i′ of the shutter driving member 131 are inserted into the grooves 11d and 11d′, respectively, from one end with the stopper portion 11m and the shutter driving member 131 is attached to the supporting body 111 so as to slide along the grooves 11d and 11d′. The protrusions 31i and 31i′ of the shutter driving member 131 are engaged with the supporting body 111 so as to sandwich both sides of the supporting body 111 between them. Thus, the shutter driving member 131 can slide without coming off the supporting body 111. Also, the stopper portion 11m prevents the protrusions 31i and 31i′ from dropping off the insertion end of the grooves 11d and 11d′.

In this preferred embodiment, the grooves are cut on both sides of the supporting body 111 and the supporting body 111 is sandwiched between a pair of protrusions that fits with those grooves, thereby preventing the shutter driving member 131 from dropping off. However, as long as the shutter driving member 131 can slide parallel to the side surface of the first type of disc cartridge with the rotational member 330 and does not come off the supporting body 111 easily, the shutter driving member 131 and the supporting body 111 may be interlocked together by any other mechanism.

If a groove is cut on the supporting body 111 parallel to the side surface of the first type of disc cartridge with the rotational member 330 and if a protrusion that fits with that groove is provided for the shutter driving member 131, then the shutter driving member 131 can perform its slide operation with good stability. However, this groove does not have to be cut on the front or reverse side of the supporting body 111 but may be located on a side surface of the supporting body 111.

When the shutter driving member 131 is attached to the supporting body 111, the protrusion of the first fitting portion 31f has been inserted into the guide groove 11g of the supporting body 111. The guide groove 11g is provided along the groove 11d. However, the guide groove 11g is not straight but has a predetermined profile. As the shutter driving member 131 slides, the protrusion of the first fitting portion 31f is driven according to this profile such that the first fitting portion 31f goes toward or away from the first type of disc cartridge 300 held on the supporting body 111. More specifically, if the shutter driving member 131 is slid so as to open the shutters of the first type of disc cartridge 300, the first fitting portion 31f contacts with a portion of the rotational member 330 of the first type of disc cartridge 300 other than the first notch 331, thereby retracting the first fitting portion 31f from the rotational member 330 such that the rotational member 330 is not driven. This operation will be described in detail with reference to FIG. 10 and FIGS. 11 through 13.

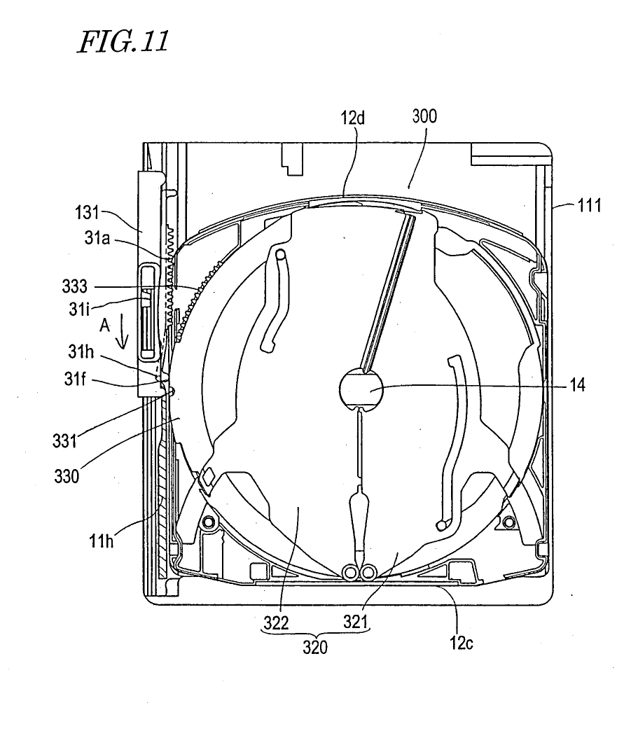

FIGS. 11 through 13 show the structures of the disc cleaner and first type of disc cartridge 300 with the lower shell 312 removed in a situation where the first type of disc cartridge 300 is held on the supporting body 111 and the shutter driving member 131 is slid. For the sake of simplicity of illustration, the locking member 325 is not shown. As shown in FIGS. 10(a) and 11, while the shutters 320 of the first type of disc cartridge 300 are still closed, the sliding member 131 is moved in the direction pointed by the arrow A. Since the guide groove 11h extends linearly as shown in FIG. 10(a), the first fitting portion 31f can move without retracting. As the first fitting portion 31f is getting closer to the rotational member 330 of the first type of disc cartridge 300, the protrusion 31h of the first fitting portion 31f soon reaches a portion 11g of the guide groove 11h that bends away from the first type of disc cartridge 300. As a result, the protrusion 31h moves according to the profile of the guide groove 11h and the first fitting portion 31f retracts so as to avoid contact with the rotational member 330 as shown in FIG. 11.

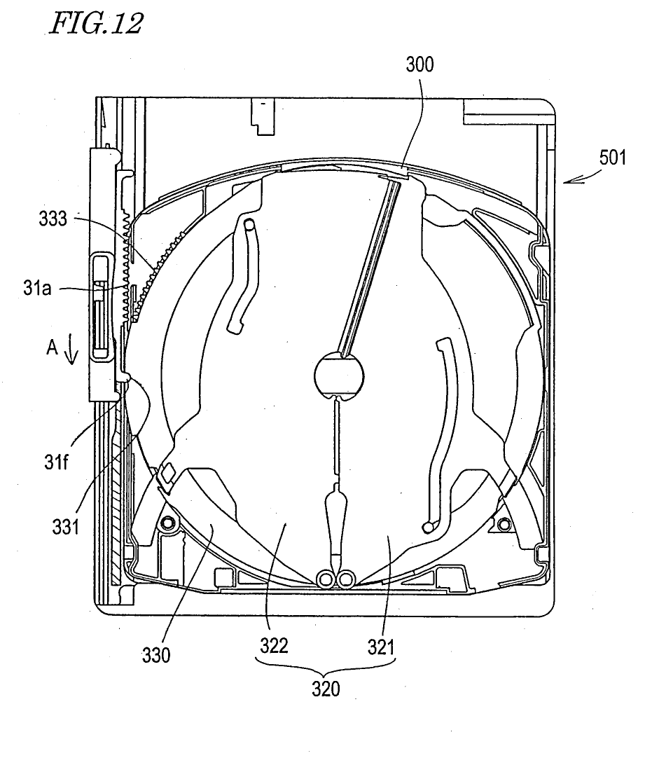

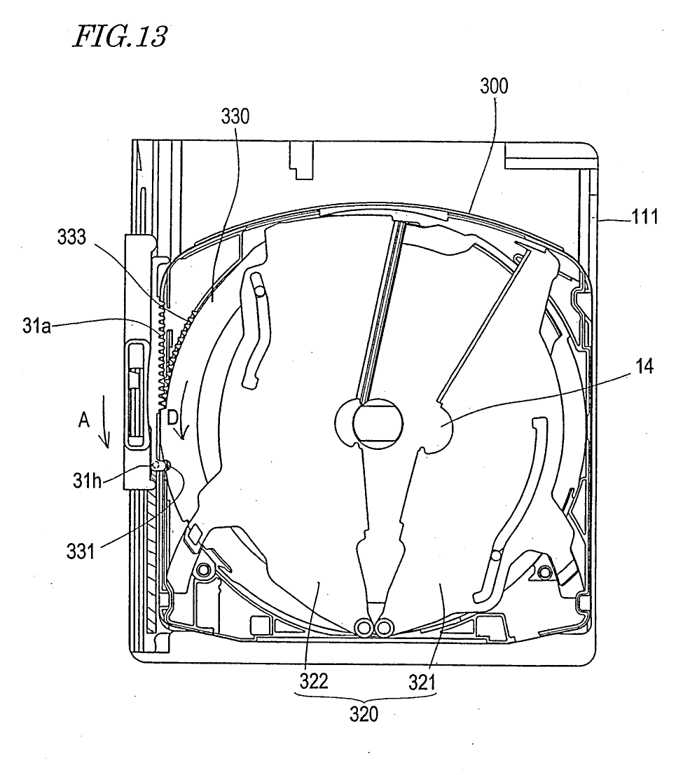

As the shutter driving member 131 further moves, the protrusion 31h is driven according to the profile of the guide groove 11h so as to get closer to the rotational member 330 as shown in FIG. 12. Thus, the first fitting portion 31f soon fits into the first notch 331 of the rotational member 330. Then, as the shutter driving member 131 moves, the rotational member 330 turns in the direction pointed by the arrow D. In the meantime, the shutters 320 interlocked with the rotational member 330 also start its opening operation.

As shown in FIG. 13, as the rotational member 330 further turns along with the shutter driving member 131 moving, the gear portion 333 soon gets engaged with the rack 31a. As shown in FIG. 10(a), the protrusion 31h has reached the widened portion of the guide groove 11h. That is why as the rotational member 330 turns, the protrusion 31h can go slightly away from the rotational member 330 and the first fitting portion 31f disengages itself from the first notch 331 and lands on a portion of the side surface between the first notch 331 and the gear portion 333. Thereafter, the rotational member 330 turns due to the engagement between the rack 31a and the gear portion 333 and keeps turning due to the engagement between the second fitting portion 31g and the second notch 332 until the shutters 320 are fully opened. As a result, the optical disc 1 stored in the first type of disc cartridge 300 is exposed through the window 312w.

It should be noted that when the shutters 320 are fully opened, the second fitting portion 31g has fitted into the second notch 332 of the rotational member 330 as shown in FIG. 3. Accordingly, even without being driven by the guide groove, the second fitting portion 31g can get fitted into the second notch 332 of the rotational member 3330 at an appropriate timing. The operation of closing the shutters can be done by operating the respective members in quite the opposite directions. The second type of disc cartridge 51 can be held as already described for the first preferred embodiment.

Thus, according to this preferred embodiment, the shutter driving member 131 can interlock with the rotational member 330 of the first type of disc cartridge 300 and can open the shutters by performing its sliding operation.

### EMBODIMENT 3

Hereinafter, a third preferred embodiment of a disc cleaner according to the present invention will be described with reference to the accompanying drawings.

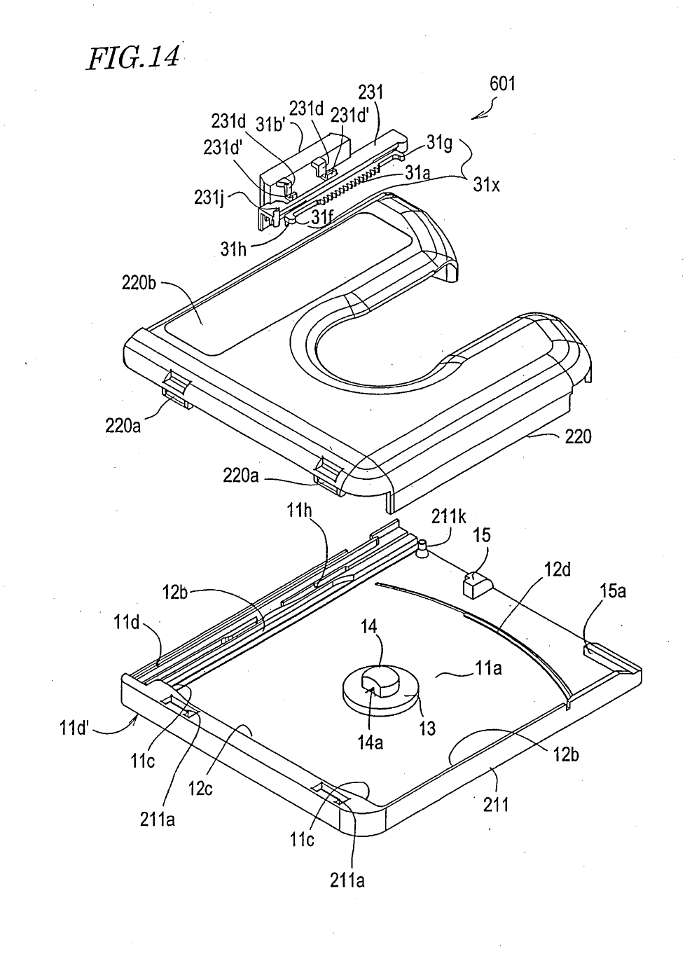

FIG. 14 is an exploded perspective view of a disc cleaner 601. The disc cleaner 601 includes a supporting body 211, a shutter driving member 231 and a lid 220. As in the second preferred embodiment described above, the disc cleaner 601 further includes a rotary knob, which is not shown in FIG. 14 because the knob has the same structure as the rotary knob 21 of the first preferred embodiment. Also, any component of this preferred embodiment, having the same function as the counterpart of the first or second preferred embodiment described above, is identified by the same reference numeral.

Unlike the disc cleaner 501 of the second preferred embodiment, the disc cleaner 601 of this preferred embodiment further includes a lid 220 for covering the first type of cartridge 300 held on the supporting body 211 and the shutter driving member 231 is attached to that lid 220.

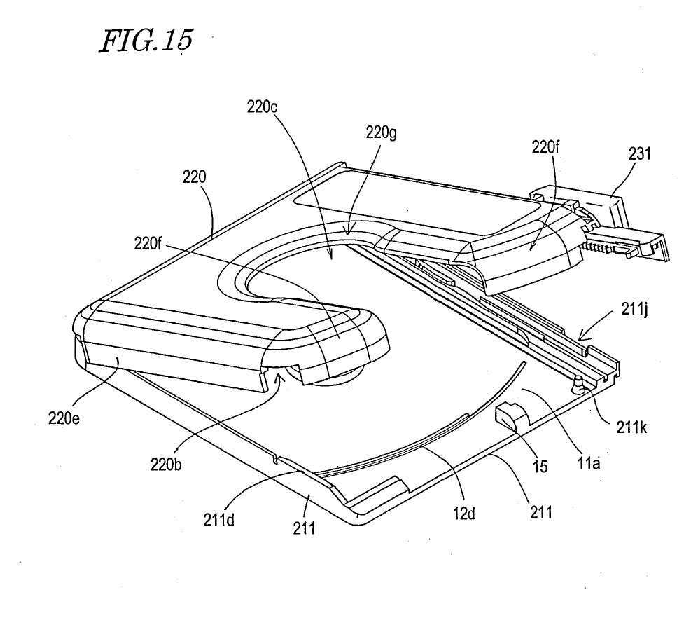

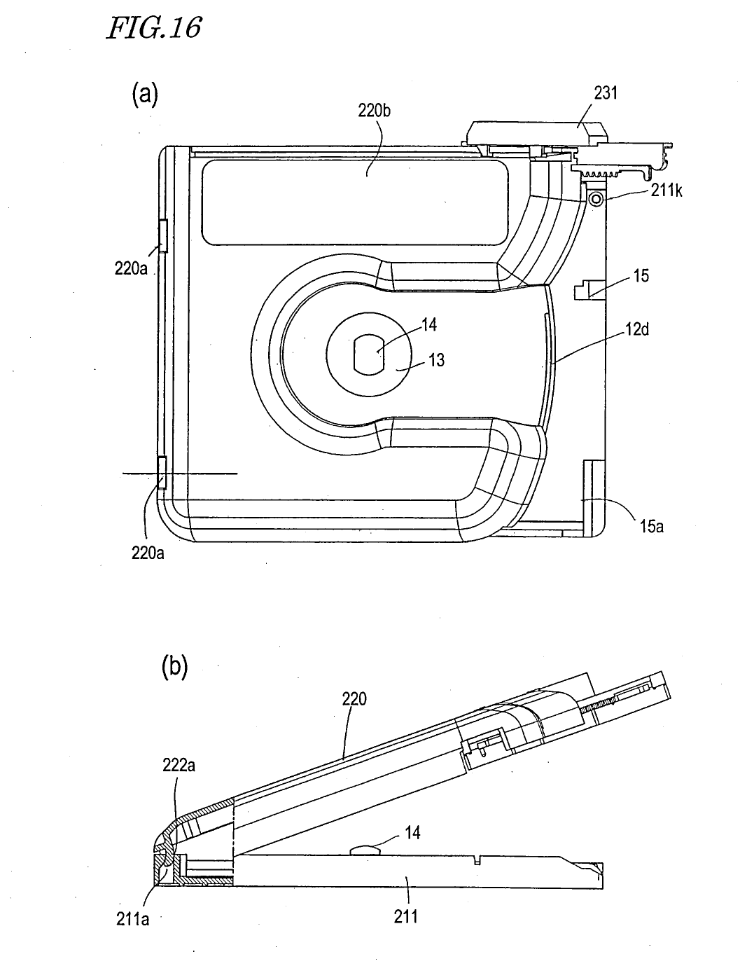

FIGS. 15, 16(a) and 16(b) are respectively a perspective view, a top view and a side view illustrating the disc cleaner 601 with the lid 220 opened.

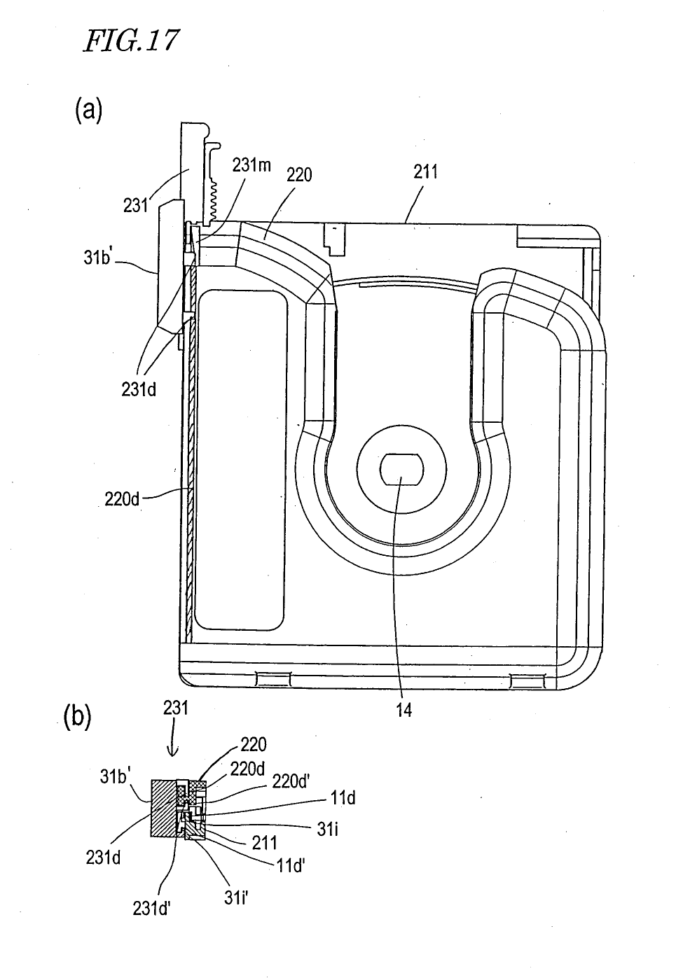

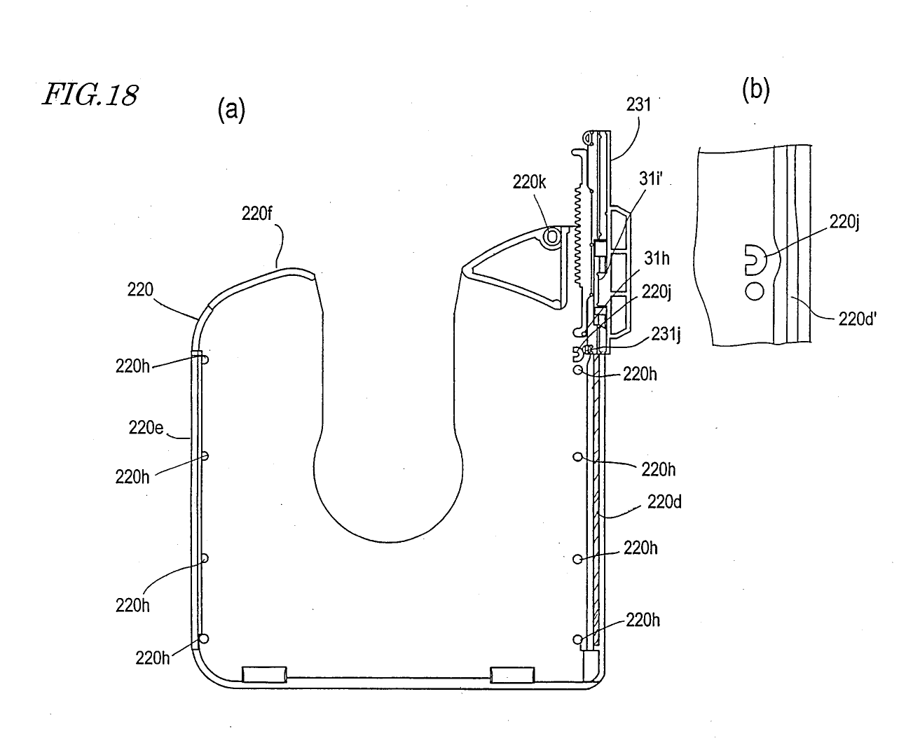

FIG. 17(a) is a top view illustrating the disc cleaner 601 with the lid 220 opened and FIG. 17(b) is a cross-sectional view of its shutter driving member 231 as viewed perpendicularly to its sliding direction. FIG. 18(a) is a plan view of the lid 220 as viewed from under the supporting body 211 and FIG. 18(b) is a partial enlarged view thereof. Hereinafter, the structure of the disc cleaner 601 will be described with reference to these drawings.

As in the second preferred embodiment, the supporting body 211 has the first holding plane 12a, second holding plane 11a, disc supporting plane 13, convex portion 14, shutter stopper 15, front end wall 15a and protrusion 12d. These members and portions function in quite the same way as the counterparts of the second preferred embodiment described above. In addition, the supporting body 111 also has the grooves 11d, 11d′ and guide groove 11h as in the second preferred embodiment, too.

To prevent the disc 10 from contacting with, and getting scratched by, the cartridge body 310 or shutters 320 while the operator is opening or closing the shutters with the first type of cartridge 300 pressed with his or her fingers during the disc cleaning operation, the lid 220 covers the first type of cartridge 300 held on the supporting body 211. That is why the lid 220 may be separate from the supporting body 111. From a handiness standpoint, however, the lid 220 is preferably supported so as to turn on one side surface of the supporting body 211. For that purpose, the lid 220 has a pair of fitting protrusions 220a. The supporting body 211 includes a pair of receiving portions 211a for supporting the lid 220 in rotatable position by receiving the fitting protrusions 220a inserted near one side surface thereof.

In cleaning the disc in the second type of disc cartridge 51, however, the lid 220 is not necessary. That is why the fitting protrusions 220a and receiving portions 211a preferably fit each other so as to readily get disengaged from each other and remove the lid 220 in cleaning the second type of disc cartridge 51.

The lid 220 covers the first type of cartridge 300 held on the supporting body 211. Thus, at least part of the lid 220 is preferably transparent to the point that the operator can see if the first type of cartridge 300 is properly held on the supporting body 211 even when the cartridge 300 is covered with the lid 220. More preferably, the overall lid 220 is made of a transparent resin.

The lid 220 has an opening 220c corresponding to the window 312w that opens when the shutters of the first type of cartridge 300 open. A portion of the lid 220 near the opening 220c preferably defines a sidewall 220g extending toward the supporting body 211. In that case, the gap between the lid 220 and the first type of cartridge 300 can be so narrow as to prevent the operator from putting his or her finger through the opening 220c. A side of the lid 220 opposite to its side with the fitting protrusions 220a defines a front wall 220f. Also, another side of the lid 220, facing the side to which the shutter driving member 231 is attached, defines a sidewall 220e. Optionally, the sidewalls 220g, 220e and front wall 220f may define a single curved surface.

A notch 220b is provided between the sidewall 220e and the front wall 220f to prevent the lid 220 from interfering with the sidewall 211d of the supporting body 211. When the lid 220 is closed, the front wall 220f contacts with the second holding plane 11a of the supporting body 211.

Also, as shown in FIG. 18(a), the reverse side of the lid 220 that faces the supporting body 211 includes a plurality of position regulating portions 220h. The position regulating portions 220h regulate the vertical position of the first type of disc cartridge 300 so as to prevent the cartridge 300 from bouncing upward from the supporting body 211 once the lid 220 has been closed. Nevertheless, the position regulating portions 220h preferably do not contact with the first type of disc cartridge 300. This is because if those portions 220h are in contact with the cartridge 300, external force is easily applied to the first type of disc cartridge 300 when the user presses the lid 220 with his or her fingers.

The supporting body 211 has a pin 211k, which is inserted into a hole 220k of the lid 220 closed, thereby horizontally positioning the lid 220 with respect to the supporting body 211 and also preventing the lid 220 from shifting from the supporting body 211 due to external force applied during the cleaning operation.

The lid 220 may have a space 220b to which a sticker giving instructions on how to clean a disc, for example, may be attached. Particularly when such a sticker attaching space 220b is provided near the shutter driving member 231, the proper position of the shutter driving member 231, as well as the cleaning procedure, may be shown on that sticker. For example, it can be shown on the sticker where the shutter driving member 231 should be positioned when the first type of disc cartridge 300 is held on the supporting body 211 or when the disc cleaned is removed from the first type of disc cartridge 300. Then, the user can use the disc cleaner 601 more easily and more properly.

Next, the shutter driving member 231 will be described. The shutter driving member 231 includes a knob portion 31b′ and an interlocking portion 31X. The structure of the interlocking portion 31X is the same as that of the second preferred embodiment. The shutter driving member 231 includes protrusions 231d, 231d′ that stick out so as to face each other. As shown in FIGS. 17(a) and 18(a), grooves 220d′ and 220d are cut on one side of the lid 220 that faces the supporting body 211 and on the opposite side thereof, respectively. When the lid 220 is closed, the grooves 220d′ and 220d extend parallel to the side surface of the first type of disc cartridge 300 with the rotational member 330. A stopper portion 231m is provided at one end of the groove 220d.

The protrusions 231d′ and 231d of the shutter driving member 231 are inserted into the grooves 220d′ and 220d, respectively, from one end with the stopper portion 231m and the shutter driving member 231 is attached to the lid 220 so as to slide along the grooves 220d′ and 220d. The protrusions 231d′ and 231d of the shutter driving member 231 are engaged with the lid 220 so as to sandwich both sides of the lid 220 between them. Thus, the shutter driving member 231 can slide without coming off the lid 220. Also, the stopper portion 231m prevents the protrusion 231d from dropping off the groove 220d.

As already described for the second preferred embodiment, as long as the shutter driving member 231 can slide parallel to the side surface of the first type of disc cartridge with the rotational member 330 and does not come off the lid 220 easily, the shutter driving member 231 and the lid 220 may be interlocked together by any other mechanism.

The shutter driving member 231 is provided to turn the rotational member 330 of the first type of disc cartridge 300. Thus, after the first type of disc cartridge 300 has been put on the supporting body 211, the lid 220 needs to be closed and the shutter driving member 231 needs to get engaged with the supporting body 211, too, before starting to be slid. As shown in FIG. 17(b), the supporting body 211 also has the grooves 11d and 11d′ having the same structure as the counterparts of the second preferred embodiment. The shutter driving member 231 too has the protrusions 31i and 31i′ with the same structure as the counterparts of the second preferred embodiment. These grooves and protrusions engage with each other as already described for the second preferred embodiment. However, the protrusion 31i′ of the shutter driving member 231 needs to fit into the groove 11d′ on the reverse side of the supporting body 211.

That is why the supporting body 211 has a notch 211j that communicates with the groove 11d′ as shown in FIG. 14. When the lid 220 is closed, the protrusion 31d′ of the shutter driving member 231 is inserted through the notch 211j. To ensure this insertion, at least the shutter driving member 131 or the lid 220 preferably has a fixing structure for fixing the shutter driving member 231 to the lid 220 where the protrusion 31i′ is insertable into the notch 2iij that communicates with the groove 11d′. For example, as shown in FIG. 18(b), in order to prevent the shutter driving member 131 from going backward once the shutter driving member 131 has reached one end of the grooves 220d and 220d′ so as to contact with the stopper portion 211m, a hook 231j provided for the shutter driving member 231 is made to contact with a receiving portion 220j provided for the supporting body 211. By arranging the notch 211j such that the protrusion 31i′ of the shutter driving member 231 can be inserted into the notch 211j that communicates with the groove 11d′ at this position, the protrusion 31i′ can get fitted into the groove 11d′ through the notch 211j when the lid 220 is closed.

The shutters of the first type of disc cartridge 300 can be opened and closed by sliding the shutter driving member 231 as already described for the second preferred embodiment.

As also mentioned above, the second type of disc cartridge 51 can be cleaned in the same procedure as that described for the first preferred embodiment with the lid 220 removed.

As described above, according to this preferred embodiment, the shutter driving member 231 is attached to the lid 220. Accordingly, unless the lid 220 is closed, the shutters of the first type of disc cartridge 300 cannot be opened or closed and the disc stored there cannot be cleaned, either. In other words, whenever the disc stored in the first type of disc cartridge 300 is cleaned, the lid 220 must be closed. As a result, it is possible to avoid an unwanted situation where the person doing the cleaning operation happens to apply significant external force to the first type of disc cartridge 300 and scratch the disc accidentally.

Neither the second preferred embodiment nor third preferred embodiment has spaces for storing the rotary knob and cleaning liquid bottle as described for the first preferred embodiment. Optionally, those spaces may also be provided as in the first preferred embodiment.

### INDUSTRIAL APPLICABILITY

The present invention provides a disc cleaner that can clean a disc stored with one side thereof exposed in a disc cartridge where shutters are opened and closed by turning a rotational member.

The disc cleaner of the present invention can clean both a disc stored in any of disc cartridges with various shapes and a bare disc alike.

1. A disc cleaner comprising:
a supporting body including a first holding plane, a disc supporting plane and a convex portion, wherein the first holding plane holds a first type of disc cartridge, which exposes one side of a disc therein and which includes a rotational member for opening and closing shutters, such that the exposed side of the disc faces the first holding plane, the disc supporting plane is located higher than the first holding plane and contacts with a non-storage region of the disc around its center hole, thereby supporting the disc thereon, and the convex portion fits into the center hole of the disc so as to stick out of the center hole;
a shutter driving member for turning the rotational member of the first type of disc cartridge; and
a rotary knob including a contact plane that contacts with the non-storage region of the disc around its center hole and a concave portion that fits the convex portion so as to turn against the convex portion.

2. The disc cleaner of claim 1, wherein the supporting body further includes a second holding plane for holding a second type of disc cartridge with a shutter that opens and closes by sliding, and a shutter stopper for keeping the shutter of the second type of disc cartridge opened, and
wherein the disc supporting plane is located higher than the second holding plane.

3. The disc cleaner of claim 2, wherein the first holding plane is located between the second holding plane and the disc supporting plane.

4. The disc cleaner of claim 1, wherein the shutter driving member includes an interlocking portion that interlocks with a shutter operating portion provided for the rotational member of the first type of disc cartridge and a knob portion, and slides parallel to a side surface of the first type of disc cartridge with the rotational member and with respect to the supporting body.

5. The disc cleaner of claim 4, further comprising a cap member for sandwiching at least a part of the interlocking portion of the shutter driving member between the supporting body and itself such that the shutter driving member will not drop off the supporting body, the cap member being attached to the supporting body.

6. The disc cleaner of claim 1, wherein the supporting body further includes an elastic member for applying elastic force to the first type of disc cartridge toward the shutter driving member.

7. The disc cleaner of claim 4, wherein the supporting body has a first groove, which extends parallel to the side surface of the first type of disc cartridge with the rotational member when the disc cartridge is held, and
wherein the shutter driving member includes a first protrusion that fits into the first groove.

8. The disc cleaner of claim 7, wherein the supporting body and the shutter driving member engage with each other such that the first protrusion of the shutter driving member does not come off the first groove of the supporting body.

9. The disc cleaner of claim 4, wherein the supporting body has a first side, for which the first and second holding planes are defined, and a second side that is opposite to the first side, and
wherein the first and second sides have a first groove and a second groove, respectively, which extend parallel to the side surface of the first type of disc cartridge with the rotational member, and
wherein the shutter driving member has a first protrusion and a second protrusion, which stick out so as to face each other and which fit into the first and second grooves, respectively.

10. The disc cleaner of claim 1, further comprising a lid that covers at least the first type of disc cartridge held on the first holding plane of the supporting body, and
wherein the lid has an opening corresponding to a window of the first type of disc cartridge that exposes when the shutters open.

11. The disc cleaner of claim 10, wherein the lid is supported in a rotatable position near one side surface of the supporting body.

12. The disc cleaner of claim 11, wherein the lid is supported on the supporting body so as to be readily removable from, and attachable to, the supporting body.

13. The disc cleaner of claim 10, wherein the lid has a side surface extending toward the supporting body around the opening.

14. The disc cleaner of claim 10, wherein the lid has a raised position regulating portion on one side that faces the supporting body, the position regulating portion regulating vertical motion of the first type of disc cartridge that is held on the supporting body.

15. The disc cleaner of claim 10, wherein at least part of the lid is transparent to the point that the first type of disc cartridge held on the first holding plane of the supporting body is seen though the lid.

16. The disc cleaner of claim 10, wherein the lid has a first groove, which extends substantially parallel to the side surface of the first type of disc cartridge with the rotational member when the disc cartridge is held, and
wherein the shutter driving member has a first protrusion that fits into the first groove.

17. The disc cleaner of claim 16, wherein the lid and the shutter driving member engage with each other such that the first protrusion of the shutter driving member does not come off the first groove of the lid.

18. The disc cleaner of claim 10, wherein the lid has a first side that faces the supporting body and a second side that is opposite to the first side, and
wherein the first and second sides have a first groove and a second groove, respectively, which extend parallel to the side surface of the first type of disc cartridge with the rotational member, and
wherein the shutter driving member has a first protrusion and a second protrusion, which stick out so as to face each other and which fit into the first and second grooves, respectively.

19. The disc cleaner of claim 10, wherein the shutter driving member has a third protrusion, and
wherein the supporting body has a third groove, which extends parallel to the side surface of the first type of disc cartridge with the rotational member when the disc cartridge is held, and which fits with the third protrusion of the shutter driving member, and a notch that communicates with the third groove such that the third protrusion of the shutter driving member is inserted into the third groove when the lid is attached to the supporting body so as to cover the first type of disc cartridge.

20. The disc cleaner of claim 19, wherein at least one of the shutter driving member and the lid has a fixing structure for fixing the shutter driving member onto the lid at a position where the third protrusion of the shutter driving member is insertable into the notch that communicates with the third groove.

21. The disc cleaner of claim 10, wherein the interlocking portion of the shutter driving member includes a rack and first and second fitting portions, which respectively engage with a gear portion and first and second notches that are provided for the rotational member of the first type of disc cartridge, the gear portion being interposed between the first and second notches, the first and second fitting portions being supported elastically on the rack so as to sandwich the rack between themselves.

22. The disc cleaner of claim 10, wherein the first fitting portion has a protrusion and contacts with the rotational member earlier than the second fitting portion in opening the shutters of the first type of disc cartridge, and
wherein the supporting body has a guide groove that receives the protrusion of the first fitting portion, and
wherein if the shutter driving member has been moved so as to open the shutters of the first type of disc cartridge, the guide groove drives the protrusion of the first fitting portion such that the first fitting portion contacts with a portion of the rotational member of the first type of disc cartridge other than the first notched portion and keeps the rotational member from turning, thereby retracting the first fitting portion.

23. The disc cleaner of claim 1, wherein the convex portion of the supporting body has two notched portions so as not to interfere with protrusions that are provided for the second type of disc cartridge so as to stick out of the center hole of the disc.

24. The disc cleaner of claim 1, wherein the supporting body includes a storage portion for storing the rotary knob and another storage portion for storing a bottle of a cleaning liquid for cleaning the first disc.
